(19) United States
(12) Patent Application Publication
(10) Pub. No.: US 2024/0018938 A1
(43) Pub. Date: Jan. 18, 2024

(54) WIND TURBINE BLADE HAVING BUCKLING-RESISTANT SPAR CAPS

(71) Applicant: LM WIND POWER A/S, Kolding (DK)

(72) Inventors: Klavs JESPERSEN, Kolding (DK); Lars NIELSEN, Kolding (DK)

(21) Appl. No.: 18/036,146

(22) PCT Filed: Dec. 6, 2021
(86) PCT No.: PCT/EP2021/084404

§ 371 Date: May 9, 2023

(30) Foreign Application Priority Data
Dec. 9, 2020 (EP) 2019405.6

(51) Int. Cl. F03D 1/06

(52) U.S. Cl. CPC F03D 1/0682; F05B 2280/6003; F05B 2230/50

(57) ABSTRACT

A wind turbine blade comprising a shell, a carbon fibre-reinforced suction-side spar cap, a carbon fibre-reinforced pressure-side spar cap, at least a first shear web connected to the spar caps, one or more suction-side buckling reinforcement elements each being formed of a material different from the suction-side spar cap and being positioned on the interior surface of the suction-side spar cap and at a distance from the suction-side end of the first shear web, and one or more pressure-side buckling reinforcement elements each being formed of a material different from the pressure-side spar cap and being positioned on the interior surface of the pressure-side spar cap and at a distance from the pressure-side end of the first shear web.

### TECHNICAL FIELD

The present disclosure relates to a wind turbine blade and a method of manufacturing such a wind turbine blade.

### BACKGROUND

Wind power provides a clean and environmentally friendly source of energy. Wind turbines usually comprise a tower, generator, gearbox, nacelle, and one or more wind turbine blades. The wind turbine blades capture kinetic wind energy using known airfoil principles.

Wind turbine blades are usually manufactured by forming two shell parts or shell halves from layers of woven fabric or fibres embedded in a cured resin. Spar caps or main laminates form the main load carrying components and are placed or integrated in the shell halves and may be combined with shear webs or spar beams to form structural support members. Spar caps or main laminates may be joined to, or integrated within, the inside of the suction and pressure halves of the shell.

Conventionally the spar caps were reinforced with glass fibres. However, as the blades have increased in length, the weight of such conventional spar caps increased dramatically. In order to reduce the weight of the main load carrying components, carbon fibres are increasingly used, especially in the spar caps. Carbon fibres are typically stronger than other fibre materials and thus the spar caps can be made thinner and lighter. While this has numerous advantages, a drawback is that the fibres in the spar caps are more prone to buckling, especially away from the shear webs.

While there have been attempts to solve this issue in the field, these attempts typically suffer from a complex spar cap design and/or complex manufacturing.

### SUMMARY

On this background, it may be seen as an object of the present disclosure to provide a wind turbine blade having carbon fibre spar caps that are less prone to buckling while ensuring that the blade is relatively simple and cost-effective.

Another object of the present disclosure is to provide a cost-effective and simple method of manufacturing such a wind turbine blade.

One or more of these objects may be met by aspects of the present disclosure as described in the following.

A first aspect of this disclosure relates to a wind turbine blade extending along a longitudinal axis from a root to a tip, the wind turbine blade comprising a root region and an airfoil region with the tip, the wind turbine blade comprising a chord line extending between a leading edge and a trailing edge, the wind turbine blade comprising:
a shell providing an aerodynamic airfoil shape of the wind turbine blade and comprising a pressure side and a suction side; and
a plurality of spar components extending along the longitudinal axis and providing the main bending stiffness of the wind turbine blade, and including:
   a carbon fibre-reinforced suction-side spar cap arranged adjacent to the suction side of the shell and having an interior surface facing the interior of the shell;
   a carbon fibre-reinforced pressure-side spar cap arranged adjacent to the pressure side of the shell and having an interior surface facing the interior of the shell;
   at least a first shear web having a suction-side end connected to the interior surface of the suction-side spar cap and a pressure-side end connected to the interior surface of the pressure-side spar cap;

wherein the plurality of spar components further comprises:
one or more suction-side buckling reinforcement elements each being formed of a material different from the suction-side spar cap and being positioned on the interior surface of the suction-side spar cap and at a distance from the suction-side end of the first shear web, and
one or more pressure-side buckling reinforcement elements each being formed of a material different from the pressure-side spar cap and being positioned on the interior surface of the pressure-side spar cap and at a distance from the pressure-side end of the first shear web.

This may provide the advantage of reducing the risk of fibre buckling in the suction-side and pressure-side spar caps while ensuring a simple and cost-effective spar cap arrangement.

Additionally or alternatively, each buckling reinforcement element may comprise longitudinal edges extending along the longitudinal axis, the longitudinal edges may be tapered.

Additionally or alternatively, each buckling reinforcement element may comprise chordwise edges extending along a chord of the wind turbine blade, the chordwise edges may be tapered.

Additionally or alternatively, a thickness of each of the one or more suction-side buckling reinforcement elements may be at least 50% of the thickness of the suction-side spar cap.

Additionally or alternatively, a thickness of each of the one or more pressure-side buckling reinforcement elements may be at least 50% of the thickness of the pressure-side spar cap.

This may further reduce the risk of fibre buckling in the spar caps.

A problem may arise during manufacturing using a pressurised manufacturing technique, e.g. vacuum assisted resin transfer or an autoclave, if the material of the spar caps is relatively flexible prior to curing, e.g. if using plies of uncured fibre material for the spar caps, and the material of the buckling reinforcement elements is relatively inflexible, e.g. if using a precured fibre material, since the ends of the buckling reinforcement element may imprint into the spar cap material during infusion and curing thereof and thus risk creating defects in the spar cap material.

To mitigate this risk, the suction-side and pressure-side spar caps may each comprise one or more carbon fibre-reinforced precured elements, e.g. carbon fibre pultrusions.

Using a precured material for the spar cap reduces this risk, since the precured spar cap material resists imprinting.

Additionally or alternatively, the suction-side end of the first shear web may be connected to the middle of the suction-side spar cap, and/or the pressure-side end of the first shear web may be connected to the middle of the pressure-side spar cap.

Additionally or alternatively, the suction-side buckling reinforcement elements may number at least two and a first suction-side buckling reinforcement element may be arranged between the suction-side end of the first shear web and the leading edge of the wind turbine blade and a second suction-side buckling reinforcement element may be arranged between the suction-side end of the first shear web and the trailing edge of the wind turbine blade.

Additionally or alternatively, the pressure-side buckling reinforcement elements may number at least two and a first pressure-side buckling reinforcement element may be arranged between the pressure-side end of the first shear web and the leading edge of the wind turbine blade and a second pressure-side buckling reinforcement element may be arranged between the pressure-side end of the first shear web and the trailing edge of the wind turbine blade.

Additionally or alternatively, the plurality of spar components may comprise a second shear web having a suction-side end connected to the interior surface of the suction-side spar cap and a pressure-side end connected to the interior surface of the pressure-side spar cap. The one or more suction-side buckling reinforcements may each be arranged between the suction-side end of the first shear web and the suction-side end of the second shear web. The one or more pressure-side buckling reinforcements may each be arranged between the pressure-side end of the first shear web and the pressure-side end of the second shear web.

Additionally or alternatively, each buckling reinforcement element may have a root end distanced from a root end of the respective spar cap, and a tip end distanced from a tip end of the respective spar cap.

This may save material and therefore reduce the weight of the blade.

Additionally or alternatively, the root end and/or the tip end of each buckling reinforcement element is/are distanced by at least 5%, 10%, 15%, or 20% of the blade length.

Additionally or alternatively, each buckling reinforcement element may be distanced from the root region, preferably distanced from a shoulder of the wind turbine blade between the root region and the airfoil region .

Additionally or alternatively, each buckling reinforcement element may be distanced from the tip of the wind turbine blade, preferably at least 10%, 20%, or 30% of the blade length from the tip end of the wind turbine blade.

Additionally or alternatively, each buckling reinforcement element may be covered by at least one cover layer, preferably each being a fibre layer, e.g. biaxial fibre layer.

Additionally or alternatively, each buckling reinforcement element may be a sandwich-structured composite comprising a core material sandwiched between skins, the core material may be balsa wood or a foam. The skin facing the interior of the blade may be provided by the cover layer(s) and the skin facing the exterior of the blade may be provided by the spar cap or an intermediate layer between the spar cap and the core material.

Additionally or alternatively, each buckling reinforcement element comprises or consists essentially of a glass fibre material, preferably being a pre-moulded glass fibre material, such as glass fibre pultrusions, or a glass fibre laminate material.

Additionally or alternatively, the one or more suction-side buckling reinforcement elements may number at least two buckling reinforcement elements extending in parallel and being spaced apart in continuation of each other, and/or wherein the one or more pressure-side buckling reinforcement elements number at least two buckling reinforcement elements extending in parallel and being spaced apart in continuation of each other.

Additionally or alternatively, each buckling reinforcement element may extend in the airfoil region of the wind turbine blade.

Additionally or alternatively, each buckling reinforcement element may be formed integrally with the respective spar cap.

This may be a particularly simple arrangement of integrating the buckling reinforcement element with the spar caps.

Additionally, the buckling reinforcement elements may be infused and cured together with the respective spar caps, such as via a resin transfer infusion moulding process.

A second aspect of this disclosure relates to a method of manufacturing a wind turbine blade extending along a longitudinal axis from a root to a tip, the wind turbine blade comprising a root region and an airfoil region with the tip, the wind turbine blade comprising a chord line extending between a leading edge and a trailing edge, the method comprising the steps of:
providing a suction-side shell part in a first mould;
arranging a first carbon fibre material on the suction-side shell part;
arranging a suction-side buckling reinforcement element on the first fibre material;
infusing the first carbon fibre material and the suction-side buckling reinforcement element with a first resin;
curing the first resin to form a cured suction-side shell part integrated with a suction-side spar cap and the suction-side buckling reinforcement element;
repeating the above step to form a cured pressure-side shell part integrated with a pressure-side spar cap and a pressure-side buckling reinforcement element in a second mould;
closing the suction-side shell part and the pressure-side shell part so as to form a shell providing an aerodynamic airfoil shape of the wind turbine blade; and
connecting a suction-side end of a first shear web to an interior surface of the suction-side spar cap at a distance from the suction-side buckling reinforcement element and a pressure-side end of the first shear web to an interior surface of the pressure-side spar cap at a distance from the pressure-10 side buckling reinforcement element.

A person skilled in the art will appreciate that any one or more of the above aspects of this disclosure and embodiments thereof may be combined with any one or more of the other aspects of this disclosure and embodiments thereof.

### BRIEF DESCRIPTION OF THE DRAWINGS

Embodiments of this disclosure will be described in more detail in the following with regard to the accompanying figures. The figures show one way of implementing the present invention and are not to be construed as being limiting to other possible embodiments falling within the scope of the attached claim set.

FIG. 1 is a schematic perspective view of a wind turbine,

FIG. 2 is a schematic perspective view of a wind turbine blade for a wind turbine as shown in FIG. 1,

FIG. 3a is a schematic side view of the wind turbine blade outlining a first arrangement of spar components,

FIG. 3b is a schematic side view of the wind turbine blade outlining a second arrangement of spar components,

FIG. 4a is a schematic chordwise cross-sectional detail view of the wind turbine blade showing a first embodiment of spar components, and

FIG. 4b is a schematic chordwise cross-sectional detail view of the wind turbine blade showing a second embodiment of spar components.

### DETAILED DESCRIPTION OF THE INVENTION

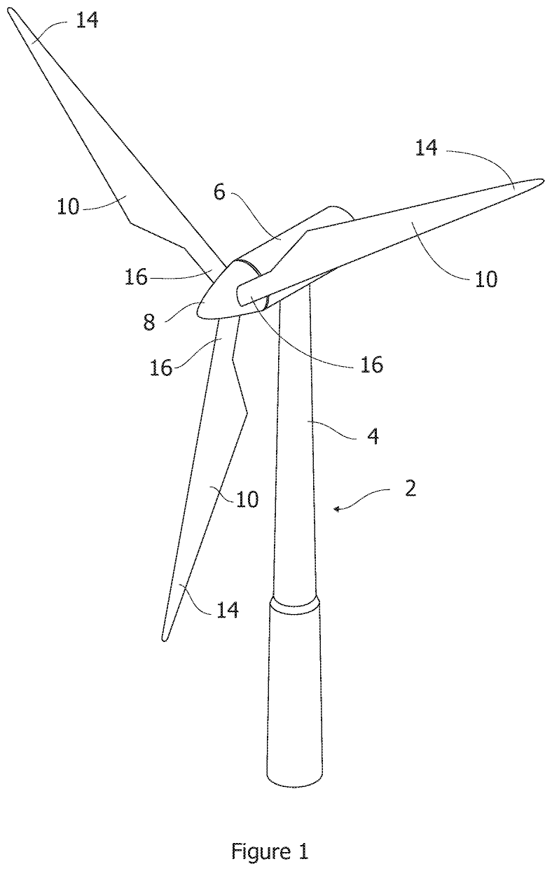

FIG. 1 illustrates a conventional modern upwind wind turbine 2 according to the so-called “Danish concept” with a tower 4, a nacelle 6 and a rotor with a substantially horizontal rotor shaft which may include a tilt angle of a few degrees. The rotor includes a hub 8 and three blades 10 extending radially from the hub 8, each having a blade root 16 nearest the hub and a blade tip 14 furthest from the hub 8.

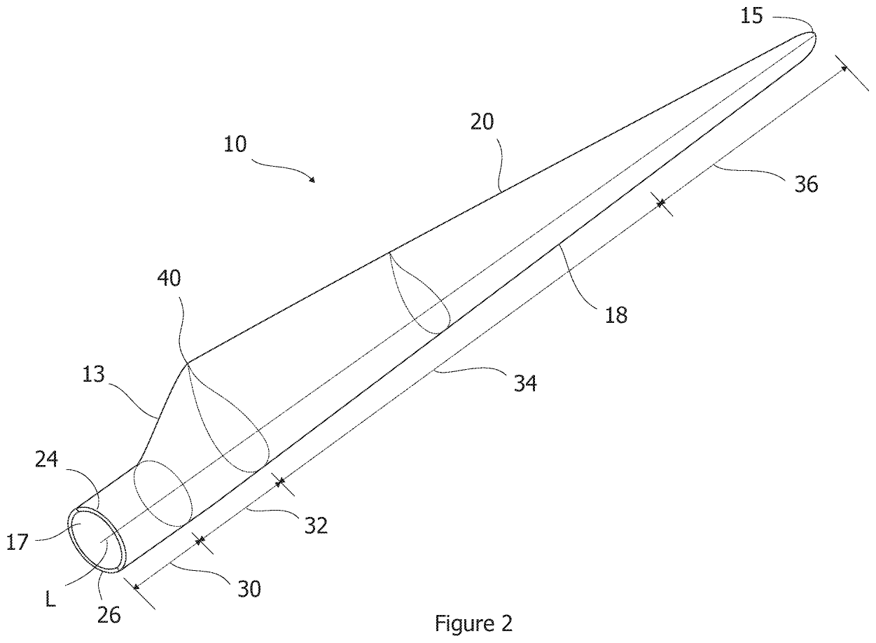

FIG. 2 shows a schematic view of an exemplary wind turbine blade 10. The wind turbine blade 10 has the shape of a conventional wind turbine blade 10 extending along a longitudinal axis L between a root end 17 and a tip end 15 and comprises a root region 30 closest to the hub, a profiled or an airfoil region 34 furthest away from the hub and a transition region 32 between the root region 30 and the airfoil region 34. The airfoil region 34 includes a tip region 36 with the tip end 15. The blade 10 comprises a leading edge 18 facing the direction of rotation of the blade 10, when the blade is mounted on the hub 8, and a trailing edge 20 facing the opposite direction of the leading edge 18.

The airfoil region 34 (also called the profiled region) has an ideal or almost ideal blade shape with respect to generating lift, whereas the root region 30 due to structural considerations has a substantially circular or elliptical cross-section, which for instance makes it easier and safer to mount the blade 10 to the hub. The diameter (or the chord) of the root region 30 may be constant along the entire root region 30. The transition region 32 has a transitional profile gradually changing from the circular or elliptical shape of the root region 30 to the airfoil profile of the airfoil region 34. The chord length of the transition region 32 typically increases with increasing radial distance from the hub. The airfoil region 34 has an airfoil profile with a chord extending between the leading edge 18 and the trailing edge 20 of the blade 10. The width of the chord decreases with increasing radial distance from the hub.

A shoulder 40 of the blade 10 is defined as the position, where the blade 10 has its largest chord length. The shoulder 40 is typically provided at the boundary between the transition region 32 and the airfoil region 34.

It should be noted that the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade being dependent on the radius from the hub.

The wind turbine blade 10 comprises a blade shell comprising two blade shell parts or half shells, a first blade shell part 24 and a second blade shell part 26, typically made of fibre-reinforced polymer. The wind turbine blade 10 may comprise additional shell parts, such as a third shell part and/or a fourth shell part. The first blade shell part 24 is typically a pressure side or upwind blade shell part. The second blade shell part 26 is typically a suction side or downwind blade shell part. The first blade shell part 24 and the second blade shell part 26 are fastened together with adhesive, such as glue, along bond lines or glue joints extending along the trailing edge 20 and the leading edge 18 of the blade 10. Typically, the root ends of the blade shell parts 24, 26 have a semi-circular or semi-oval outer cross-sectional shape. The blade shell parts 24, 26 define the aerodynamic shape of the wind turbine blade and comprise a plurality of spar components extending along the longitudinal axis and provide the main bending stiffness of the blade 10.

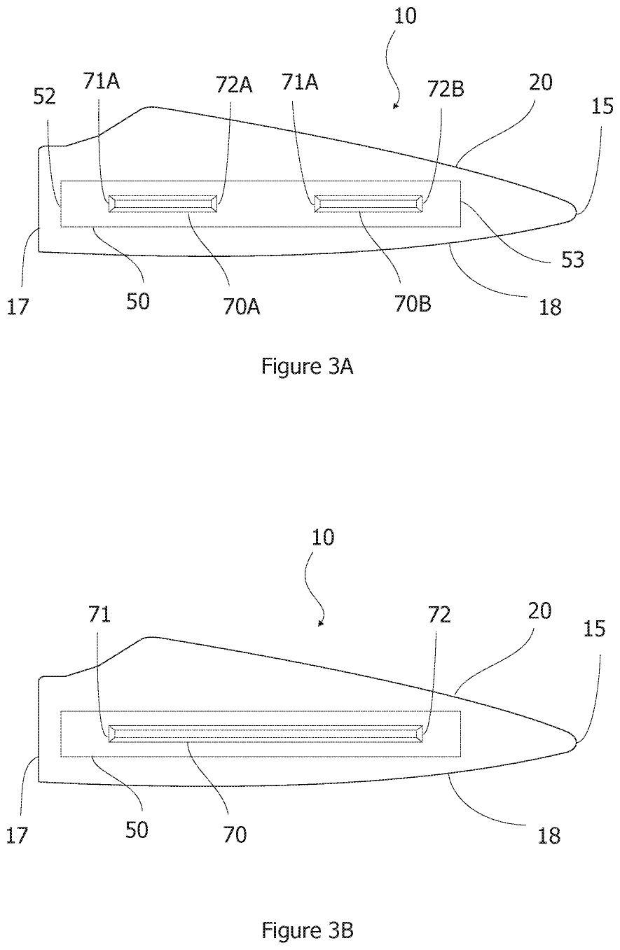

A first arrangement of spar components 50, 70A, 70B is shown in FIG. 3A which includes a carbon fibre-reinforced spar cap 50, a first buckling reinforcement element 70A, and a second buckling reinforcement element 70B. The spar cap 50 extends longitudinally from an inboard end 52 to an outboard end 53. The inboard end 52 is distanced about 5% of the blade length from the root end 17 of the blade 10. The outboard end 53 is distanced about 20% of the blade length from the tip end 15 of the blade 10. The first and second buckling reinforcement elements 70A, 70B extend in parallel and are spaced apart in continuation of each other, i.e. extending along the same axis. The first buckling reinforcement element has an inboard end 71a positioned at about 15% of the blade length from the blade root end 17 and an outboard end 72a positioned at about 33% of the blade length from the blade root end 17. The second buckling reinforcement element 70B also has a corresponding inboard end 71b positioned at about 50% of the blade length from the blade root end 17, and outboard end 72b positioned at about 70% of the blade length from the blade root end 17, thus about 30% of the blade length from the blade tip end 15. The distance between the first and second buckling reinforcement elements 70A, 70B is thus about 17% of the blade length.

A second arrangement of spar components 50, 70 is shown in FIG. 3B which includes a carbon fibre-reinforced spar cap 50 and a single buckling reinforcement element 70. In this second arrangement, the spar cap 50 has the same extent as in the first arrangement, while the single buckling reinforcement element 70 has an associated inboard end 71 positioned at about 15% of the blade length from the blade root end 17, and an associated outboard end 72 positioned at about 70% of the blade length from the blade root end 17 thus about 30% of the blade length from the blade tip end 15.

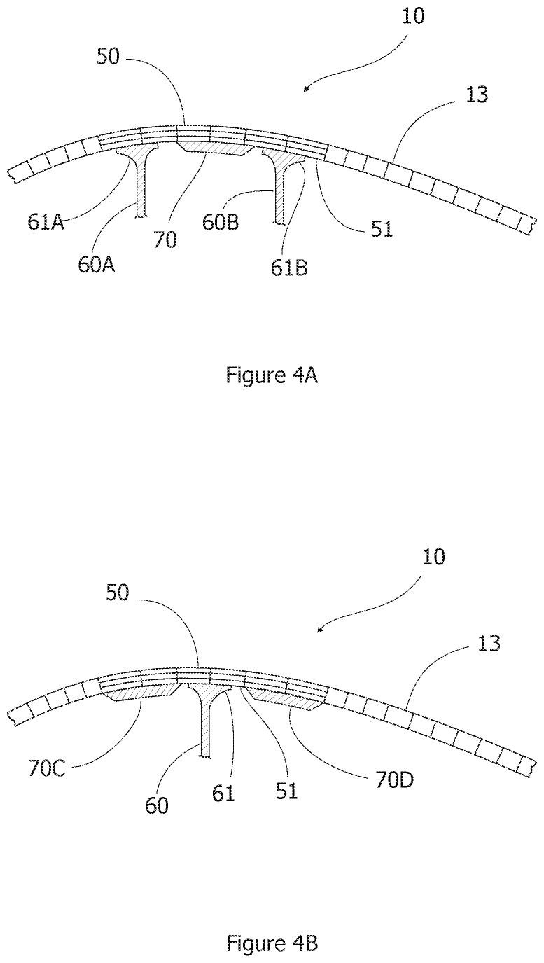

In both arrangements, each buckling reinforcement element 70, 70A, 70B has tapered longitudinal edges extending along the longitudinal axis L and faces the leading edge 18 and the trailing edge 20 respectively (e.g. see FIGS. 4A and 4B for greater detail). Each buckling reinforcement element 70, 70A, 70B further has tapered chordwise edges extending along a chord of the wind turbine blade and faces the blade root end 17 and the blade tip end 15 respectively.

FIGS. 4A and 4B show first and second embodiments of spar components 50, 60, 70, respectively. In both embodiments, the spar cap 50 is formed integrally with and fully embedded in the shell 13. The spar cap 50 comprises a number of carbon fibre pultrusions which in both embodiments are arranged in three stacks each having six pultrusions extending side-by-side along the longitudinal axis (which extends through the plane of FIG. 4A), thus totalling eighteen. Furthermore, each buckling reinforcement element 70, 70C, 70D, has a thickness of about two thirds of the spar cap 50.

As previously disclosed, FIG. 4A illustrates the first embodiment of spar components 50, 60, 70 which includes a spar cap 50, two shear webs 60A, 60B, and a single buckling reinforcement element 70. The shear webs 60A, 60B each has a shear web end 61A, 61B connected to the interior surface 51 of the spar cap 50 adjacent to opposite chordwise ends of the spar cap 50. The buckling reinforcement element 70 is positioned between the shear web ends 61A, 61B and centred on the interior surface 51 of the spar cap 50. In this first embodiment, the buckling reinforcement element 70 is a sandwich-structured composite comprising a core material of balsa wood sandwiched between the pultrusions of the spar cap and cover layers of biaxial glass fibres.

As previously disclosed, FIG. 4B illustrates the second embodiment of spar components 50, 60, 70C, 70D which includes a spar cap 50, a single central shear web 60, and two buckling reinforcement elements 70D. The shear web 60 has a shear web end 61 connected to a centre of the interior surface 51 of the spar cap 50. The buckling reinforcement element 70C is positioned between the shear web end 61 and the leading edge of the blade (i.e. to the left of the shear web 60 in FIG. 4B) and the buckling reinforcement element 70D is positioned between the shear web end 61 and the trailing edge of the blade (i.e. to the right of the shear web 60 in FIG. 4B). In this second embodiment, the buckling reinforcement elements 70C, 70D consist essentially of glass fibre pultrusions covered by cover layers of biaxial glass fibre.

The skilled person will appreciate that the described first embodiment of spar components can be arranged according to either the first or second arrangement of spar components and accordingly the second embodiment of spar components can be arranged according to either the first or second arrangement of spar components. Other arrangements and embodiments are possible within the scope of this disclosure.

### LIST OF REFERENCES

2 wind turbine
4 tower
6 nacelle
8 hub
10 blade
13 shell
14 blade tip
15 tip end
16 blade root
17 root end
18 leading edge
20 trailing edge
24 first blade shell part
26 second blade shell part
30 root region
32 transition region
34 airfoil region
36 tip region
40 shoulder
50 spar cap
51 interior surface
52 inboard end
53 outboard end
60 shear web
61 shear web end
70 buckling reinforcement element
71 inboard end
72 outboard end
L longitudinal axis

1. A wind turbine blade extending along a longitudinal axis from a root to a tip, the wind turbine blade comprising a root region and an airfoil region with the tip, the wind turbine blade comprising a chord line extending between a leading edge and a trailing edge, the wind turbine blade comprising:
a shell providing an aerodynamic airfoil shape of the wind turbine blade and comprising a pressure side and a suction side; and
a plurality of spar components extending along the longitudinal axis and providing the main bending stiffness of the wind turbine blade, and including:
a carbon fibre-reinforced suction-side spar cap arranged adjacent to the suction side of the shell and having an interior surface facing the interior of the shell;
a carbon fibre-reinforced pressure-side spar cap arranged adjacent to the pressure side of the shell and having an interior surface facing the interior of the shell;
at least a first shear web having a suction-side end connected to the interior surface of the suction-side spar cap and a pressure-side end connected to the interior surface of the pressure-side spar cap;
wherein the plurality of spar components further comprises:
one or more suction-side buckling reinforcement elements each being formed of a material different from the suction-side spar cap and being positioned on the interior surface of the suction-side spar cap and at a distance from the suction-side end of the first shear web, and
one or more pressure-side buckling reinforcement elements each being formed of a material different from the pressure-side spar cap and being positioned on the interior surface of the pressure-side spar cap and at a distance from the pressure-side end of the first shear web.

2. thickness
A wind turbine blade according to claim 1, wherein a thickness of each of the one or more suction-side buckling reinforcement elements is at least 50% of the thickness of the suction-side spar cap, and/or wherein a thickness of each of the one or more pressure-side buckling reinforcement elements is at least 50% of the thickness of the pressure-side spar cap.

3. precured elements
A wind turbine blade according to claim 1, wherein the suction-side and pressure-side spar caps each comprises one or more carbon fibre-reinforced precured elements, e.g. carbon fibre pultrusions.

4. single shear web
A wind turbine blade according to claim 1, wherein the suction-side end of the first shear web is connected to the middle of the suction-side spar cap and/or the pressure-side end of the first shear web is connected to the middle of the pressure-side spar cap.

5. double buckling reinforcement elements
wind turbine blade according to claim 1, wherein the suction-side buckling reinforcement elements number at least two and a first suction-side buckling reinforcement element is arranged between the suction-side end of the first shear web and the leading edge of the wind turbine blade and a second suction-side buckling reinforcement element is arranged between the suction-side end of the first shear web and the trailing edge of the wind turbine blade, and/or
wherein the pressure-side buckling reinforcement elements number at least two and a first pressure-side buckling reinforcement element is arranged between the pressure-side end of the first shear web and the leading edge of the wind turbine blade and a second pressure-side buckling reinforcement element is arranged between the pressure-side end of the first shear web and the trailing edge of the wind turbine blade.

6. Double shear web
A wind turbine blade according to claim 1, wherein the plurality of spar components comprises a second shear web having a suction-side end connected to the interior surface of the suction-side spar cap and a pressure-side end connected to the interior surface of the pressure-side spar cap, and wherein each of the one or more suction-side buckling reinforcements is arranged between the suction-side end of the first shear web and the suction-side end of the second shear web, and/or
wherein each of the one or more pressure-side buckling reinforcements is arranged between the pressure-side end of the first shear web and the pressure-side end of the second shear web.

7. root end and tip end of buckling reinforcement element
A wind turbine blade according to claim 1, wherein each buckling reinforcement element has:
a root end distanced from a root end of the respective spar cap, and
a tip end distanced from a tip end of the respective spar cap.

8. distanced from shoulder
A wind turbine blade according to claim 1, wherein each buckling reinforcement element is distanced from the root region.

9. distanced from tip
A wind turbine blade according to claim 1, wherein each buckling reinforcement element is distanced from the tip of the wind turbine blade, preferably at least 20% of the blade length from the tip end of the wind turbine blade.

10. cover layers
A wind turbine blade according to claim 1, wherein each buckling reinforcement element is covered by at least one cover layer, preferably each being a fibre layer, e.g. biaxial fibre layer.

11. sandwich structured composite
A wind turbine blade according to claim 1, wherein each buckling reinforcement element is a sandwich-structured composite comprising a core material sandwiched between skins.

12. glass fibre material
A wind turbine blade according to claim 1, wherein each buckling reinforcement element comprises or consists essentially of a glass fibre material, preferably being a pre-moulded glass fibre material, glass fibre pultrusions, or a glass fibre laminate material.

13. Multiple buckling reinforcement elements
A wind turbine blade according to claim 1, wherein the one or more suction-side buckling reinforcement elements number at least two buckling reinforcement elements extending in parallel and being spaced apart in continuation of each other, and/or wherein the one or more pressure-side buckling reinforcement elements number at least two buckling reinforcement elements extending in parallel and being spaced apart in continuation of each other.

14. formed integrally
A wind turbine blade according to claim 1, wherein each buckling reinforcement element is formed integrally with the respective spar cap.

15. method of manufacture
A method of manufacturing a wind turbine blade extending along a longitudinal axis from a root to a tip, the wind turbine blade comprising a root region and an airfoil region with the tip, the wind turbine blade comprising a chord line extending between a leading edge and a trailing edge, the method comprising the steps of:
providing a suction-side shell part in a first mould;
arranging a first carbon fibre material on the suction-side shell part;
arranging a suction-side buckling reinforcement element on the first fibre material;
infusing the first carbon fibre material and the suction-side buckling reinforcement element with a first resin;
curing the first resin to form a cured suction-side shell part integrated with a suction-side spar cap and the suction-side buckling reinforcement element;
repeating the above step to form a cured pressure-side shell part integrated with a pressure-side spar cap and a pressure-side buckling reinforcement element in a second mould;
closing the suction-side shell part and the pressure-side shell part so as to form a shell providing an aerodynamic airfoil shape of the wind turbine blade; and
connecting a suction-side end of a first shear web to an interior surface of the suction-side spar cap at a distance from the suction-side buckling reinforcement element and a pressure-side end of the first shear web to an interior surface of the pressure-side spar cap at a distance from the pressure-side buckling reinforcement element.
